(19) United States
(12) Patent Application Publication
(10) Pub. No.: US 2009/0109981 A1
(43) Pub. Date: Apr. 30, 2009

(54) Out-of-band management for broadband over powerline network

(76) Inventor: Michael Keselman, San Ramon, CA (US)

Correspondence Address: DICKSTEIN SHAPIRO LLP, 1825 EYE STREET NW, Washington, DC, 20006-5403, US

(21) Appl. No.: 12/289,374

(22) Filed: Oct. 27, 2008

Related U.S. Application Data
(60) Provisional application No. 60/996,021, filed on Oct. 25, 2007.

(51) Int. Cl. H04L 12/56

(52) U.S. Cl. 370/400

(57) ABSTRACT

A management system for broadband over power lines is disclosed, using wireless communications interfaced with broadband over power lines management components to establish a wireless out-of-band system management network.

### CLAIM OF PRIORITY

This patent application claims priority to U.S. Provisional Application No. 60/996,021 filed on Oct. 25, 2007 in the U.S. Patent and Trademark Office, the entire content of which is incorporated by reference herein.

### FIELD OF THE INVENTION

Described embodiments relate generally to the field of broadband communication signals transmitted over power lines, and more particularly, to the management and maintenance of such systems.

### BACKGROUND OF THE INVENTION

High-speed Internet access, commonly known as “broadband,” is defined by the FCC as Internet access providing download speeds of at least 200 kbit/s. While the demand for communications systems capable of carrying broadband Internet access continues to grow, the technology requires a transmission infrastructure. Broadband providers currently use the existing cable or telephone infrastructures to provide service into homes. As an alternative transmission medium, the existing infrastructure for power lines would provide access to many areas not covered by cable or telephone lines. The technology exists to carry a broadband Internet signal over power lines.

Broadband Over Power Line (“BPL”) technology uses the existing power line infrastructure to carry a broadband Internet signal, potentially providing access to any location connected to the power grid. A radio-frequency signal at a first location (or node) is modulated with a data signal and coupled to a power line serving as a transmission channel. The power line can be high, medium, or low voltage. The modulated RF signal's frequency is typically much higher than the AC power current. At a second node, the radio-frequency signal is coupled from the high-voltage cable to a demodulator for converting the modulated signal back to a data signal. Data is sent from the second node to the first node in a similar manner typically using either a different band of frequencies or different time slots. Attenuation of the broadband signal along the line is remedied with repeaters or regenerators, which reestablish the signal's strength. This full-duplex broadband service between the locations may simultaneously supply a variety of communication needs, such as telephone service, video service, network and Internet service, and other services requiring high-speed data transfers.

As currently practiced in the industry, a BPL system consists of multiple nodes, with a variable distance between each node depending upon the amount of users in the area and the characteristics of the BPL signal. Each node also has a component that provides configuration, management, and monitoring capabilities, herein collectively referred to as the “management component.” The management components in each consecutive node are linked to one another, providing comprehensive monitoring, management, and maintenance capabilities for the BPL system.

As currently practiced, communication with downstream management components is conducted through an in-band communication network. A system employing in-band management communication uses the same channel for communicating with the management components as is used for transmitting data, the power lines in the case of BPL. Thus, when the line for data transmission is unavailable, an in-band management system is also unavailable.

In a system employing out-of-band management communication, a secondary path establishes the link between management components, allowing for network management capabilities despite the loss of data transmission capabilities on the BPL system. Current industry practice of out-of-band management uses an additional wire as the secondary path, with each node sequentially connected. In this system, however, failure at a single node can prevent downstream transmission of management communication.

As a consequence, there exists a need in the art for a broadband over power lines management system that can provide management capabilities when the BPL connection is unavailable or when there is a failure at a node in the management system.

### BRIEF SUMMARY OF THE INVENTION

The described embodiments overcome the above deficiencies by providing a system for management of broadband over power lines (“BPL”) employing wireless communications. Embodiments of a BPL management system entail wireless communications equipment installed and interfaced with the management component at each node of the BPL network to provide separate, out-of-band management capabilities. The system can operate as a supplemental or primary management and monitoring channel when BPL connectivity is available, and as a primary managing and monitoring channel when BPL connectivity is unavailable. The capabilities provided by the management system include, but are not limited to, configuration management, software installation and upgrades, hardware and power resets, collection of system usage data and statistics, and system monitoring. Described embodiments also enable the management system to bypass a non-responsive node to maintain downstream management capabilities. Embodiments also provide wireless access to the management component for onsite personnel. Wireless communications can be used to access the management component of an embodiment of such a BPL node from a central location, as well as from locations close to the place of physical installation. A method of managing BPL by employing wireless communications is also presented, including an embodiment wherein non-responsive nodes are bypassed and an embodiment wherein management communication is maintained even where BPL connectivity is unavailable.

### BRIEF DESCRIPTION OF THE DRAWINGS

FIG. 1 is a diagram of an individual management component constructed in accordance with an embodiment described herein;

FIG. 2 is a schematic diagram of a wireless out-of-band management network for broadband over power lines constructed in accordance with an embodiment described herein;

FIG. 3 is a schematic diagram of a wireless out-of-band management network in a mesh network configuration;

FIG. 4 is a schematic diagram showing communication between a network management center and an out-of-band management network via a hard-wired and wireless connection;

FIG. 5 is a schematic diagram showing communication between a network management center and an in-band management network;

FIG. 6 is a schematic diagram showing communication between a mobile personal device and an out-of-band management network via a wireless connection;

FIG. 7 is a flow chart demonstrating a process by which a supplemental wireless management network enables both connection with nodes that have lost BPL connectivity, and bypassing of nonresponsive nodes;

FIGS. 8a through 8e illustrate a process by which nonresponsive nodes are connected to or bypassed via a wireless connection.

### DETAILED DESCRIPTION OF THE INVENTION

Embodiments described herein include a wireless out-of-band management and maintenance system for broadband over power lines (“BPL”). Embodiments employ a wirelessly transmitted signal to provide the secondary out-of-band link to and between management components. Wireless communications equipment is housed within or interfaced with each management component. The wireless signal provides BPL management capabilities including, but not limited to, configuration management, software installation and upgrades, hardware reset, and system monitoring and maintenance. The wireless communication can be used as either a primary or supplemental management network when BPL connectivity is available, and as the primary management network when BPL connectivity is unavailable.

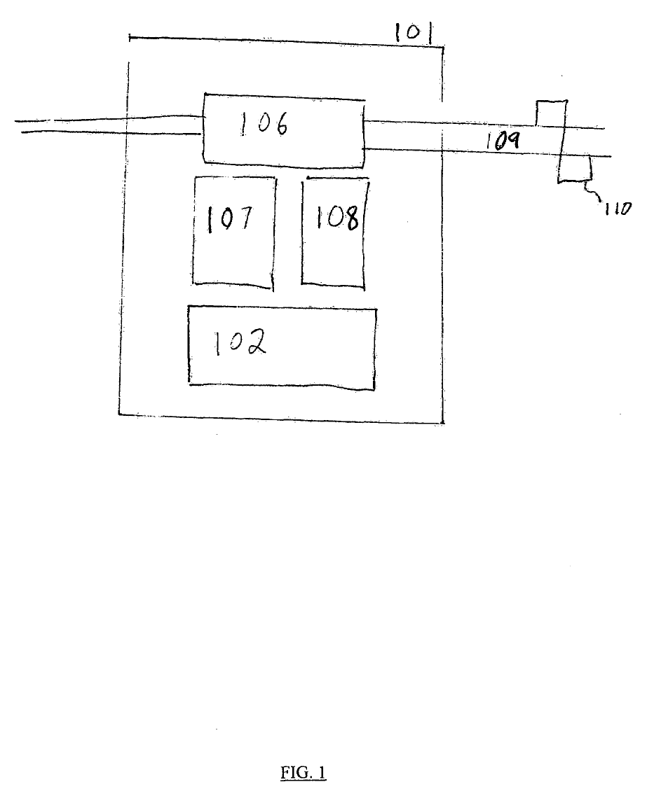

FIG. 1 is a diagram of a management component 101. Management component 101 can be installed in or interfaced with a BPL repeater or regenerator. Embodiments of management component 101 include a BPL interface component 106 for interfacing, via for example a buffer or sampler or any other interfacing means, with a BPL data signal 110 on a power line 109, and a wireless component 102 configured to include a transmitter and a receiver to send and receive a wirelessly transmitted signal. Embodiments may include a processor component 107 for processing information such as system usage or statistics. Any conventionally known processor may be used. Embodiments may also include a storage component 108, for storing data. Any conventionally known storage can be used, including hardware components. Such components include, but are not limited to, hard drives, RAM, S-RAM, ROM, EPROMS, etc. The wireless component 102 enables wireless communication with wireless components of other management components 101, and also with other wireless-enabled devices, such as portable devices used by management personnel. Each storage component 108 stores management data for an individual node. The network management infrastructure collects data from each management component 101 and stores data for the entire network at one or more locations.

In the embodiments described herein, wireless components (for example wireless component 102 of FIG. 1) may include a wireless transmitter interfaced with management components at multiple nodes in the BPL system. The wireless signal can be transmitted, for example, using an 802.11(b) standard, an unlicensed standard wireless protocol operating at 2.4 GHz frequency. This wireless standard allows for robust low-bandwidth communications over long distances, and networking with other protocols. An 802.11(b) signal can be used to transmit data in fixed point-to-point arrangements well over one kilometer in distance. This provides the capability to wirelessly connect both consecutive and nonconsecutive nodes of a BPL management system.

The 802.11(b) signal is also commonly used in wide-area networks, with a point-to-multipoint configuration range of over 30 meters, which provides the capability to interface with BPL management components via wireless-enabled portable devices. The wireless-enabled portable devices can include, but are not limited to, laptop and tablet computers, desktop computers, and personal digital assistants such as BlackBerries, PALM's, or iPhones, to name but a few. This enables interfacing by BPL management personnel within range of the wireless signal.

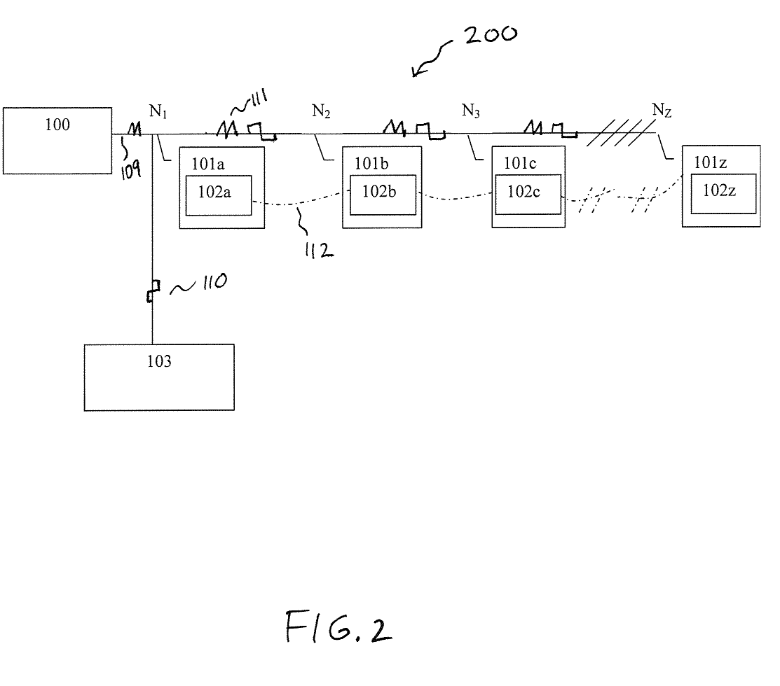

FIG. 2 is a schematic diagram of a wireless out-of-band management network for BPL 200, constructed in accordance with an embodiment described herein. The power line 109 is connected to a power substation 100 providing a power current 111, and a data signal source 103 providing a data signal 110. N₁ through N_{z} represent nodes of the BPL system. Management components 101a, through 101z at the nodes N₁ through N_{z} interface with the BPL signal and are configured to perform management functions. The management components are depicted at each node N, but they do not necessarily need to be located at each node. Instead, management components could be located at only a subset of nodes. Each management component 101a through 101z is installed or interfaced with a wireless component 102a through 102z. Wireless components 102a through 102z provide a wirelessly transmitted signal 112 enabling communication between management components 101a through 101z in an out-of-band network. This allows communication between management components 101a through 101z independent of the power line 101 carrying the BPL data signal 110 and power current 111.

In FIG. 2, the wireless components 102a through 102z are connected consecutively, with each wireless component forming a connection with only those wireless components immediately adjacent. Wireless component 102b communicates with wireless component 102a and wireless component 102c, but not wireless component 102z. Consecutive connections are suited to long, isolated lines in which the management nodes are spaced far apart.

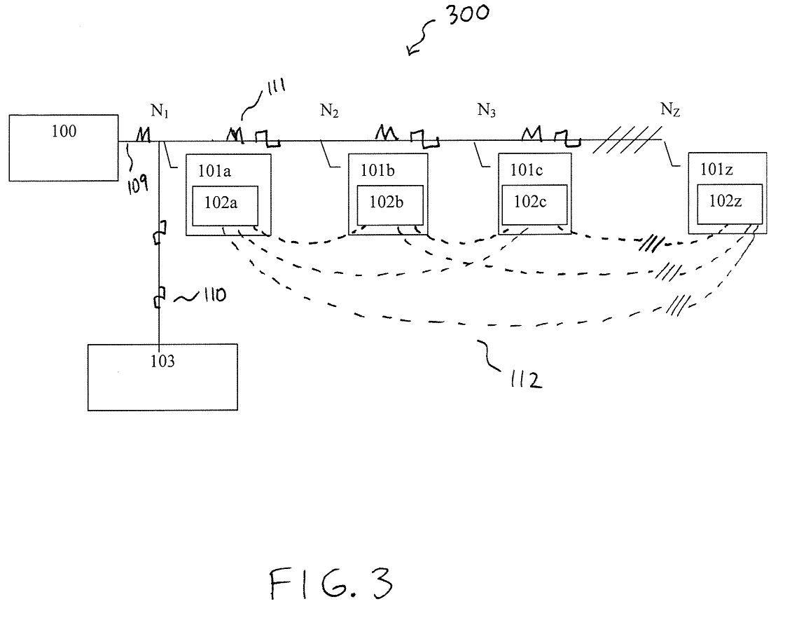

FIG. 3 depicts another embodiment of a wireless out-of-band management network 300. Similar to management network 200, the wireless components 102a through 102z are linked to adjacent wireless components. Thus, wireless component 102a communicates with adjacent wireless component 102b and wireless component 102b communicates with adjacent wireless component 102c. In management network 300, however, one or more nonconsecutive wireless components are also linked. Wireless component 102a is linked to wireless component 102c, even though wireless component 102c is not immediately adjacent to wireless component 102a. Nonconsecutive connections are suited to dense areas in which the nodes are spaced relatively closer together.

The connections formed by the wirelessly transmitted signal 112 in FIG. 2 and FIG. 3 can establish point-to-point or point-to-multipoint connections. In point-to-point connections, there is a single link between two nodes. For example, in FIG. 2, wireless component 102a may be linked in a point-to-point connection with wireless component 102b. Point-to-multipoint or broadcast connections allow a single node to connect to multiple other nodes. For example, in FIG. 3 wireless component 102a can be connected to any number of wireless components within range of the wirelessly transmitted signal 112. As shown in FIG. 3, the wireless component 102a is connected to both wireless component 102b and wireless component 102c. Point-to-multipoint connections provide multiple paths from a single location to multiple locations. Point-to-point and point-to-multipoint communications can be established between consecutive or nonconsecutive nodes. Communication is generally bidirectional, though it could also be unidirectional.

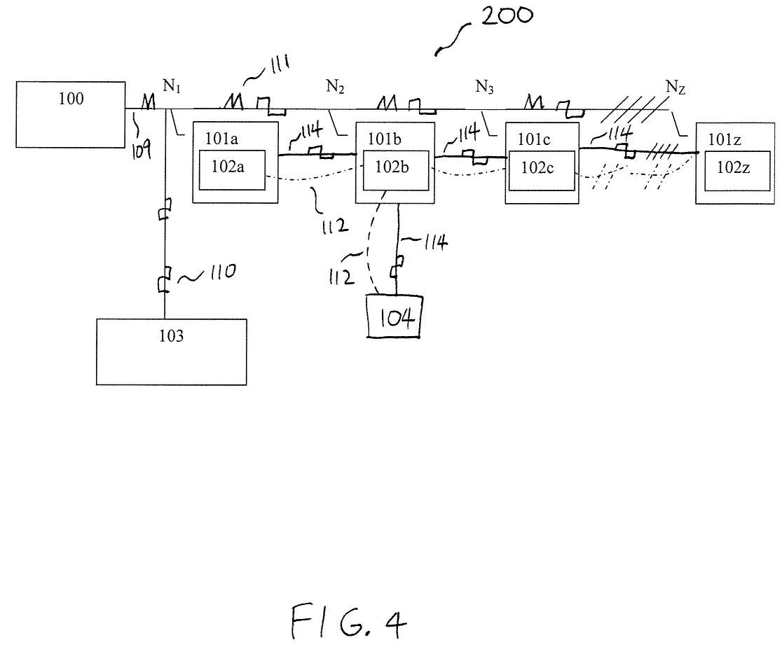

FIG. 4 is a schematic diagram showing communication between a network management center 104 and an out-of-band management network via a hard-wired and wireless connection. In FIG. 4, a network management center 104 is connected by a wired connection 114 and/or a wirelessly transmitted signal 112 to the management component 102b. This connection is used to transmit management data stored at the management component 102b to the network management center 104. In this embodiment, management components 102a, 102b, 102c and 102z are connected by wirelessly transmitted signals 112 as well as wired connections 114. The wireless connections thus form a wireless out-of-band management network infrastructure, and the wired connections form a hard-wired out-of-band management network infrastructure. Either management network infrastructure can act as a primary or secondary management network. The network management center utilizes the connections formed by the management network infrastructure to retrieve data from management components at downstream nodes, such as management components 102a, 102c and 102z.

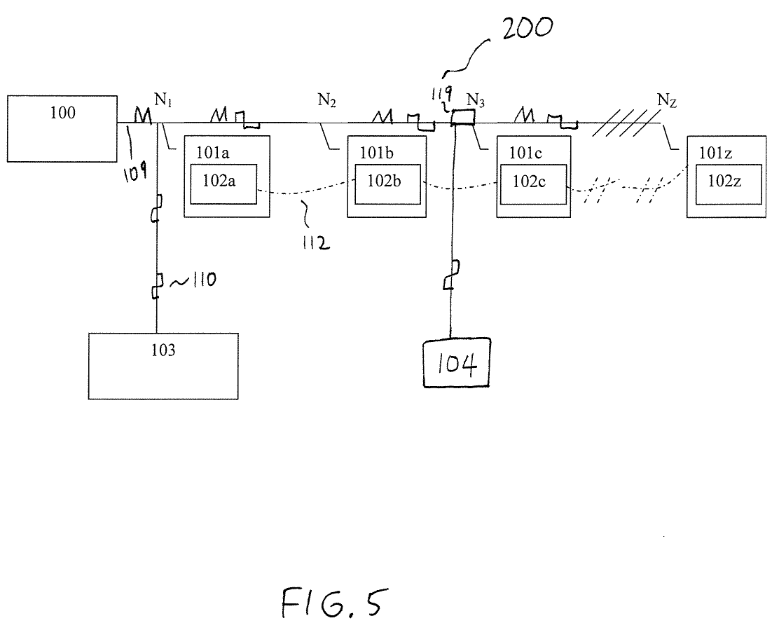

FIG. 5 is a schematic diagram of another embodiment, illustrating communication between a network management center 104 and an in-band management network. In FIG. 5, an in-band management network infrastructure is depicted. The network management center 104 is connected to the transmission channel of the BPL connection via a BPL device 119. The BPL device could be, for example, a repeater or a regenerator providing an interface with the BPL connection. In this embodiment, an in-band management network is formed, wherein the BPL connection is used for communicating management information between the network management center 104 and the management components 101a through 101z. In an embodiment, the wireless out-of band management network may only be utilized in situations in which communication along the in-band management network is not possible. The in-band management network may be preferred over the wireless out-of-band network for ordinary communications for reasons including power savings or lower maintenance costs.

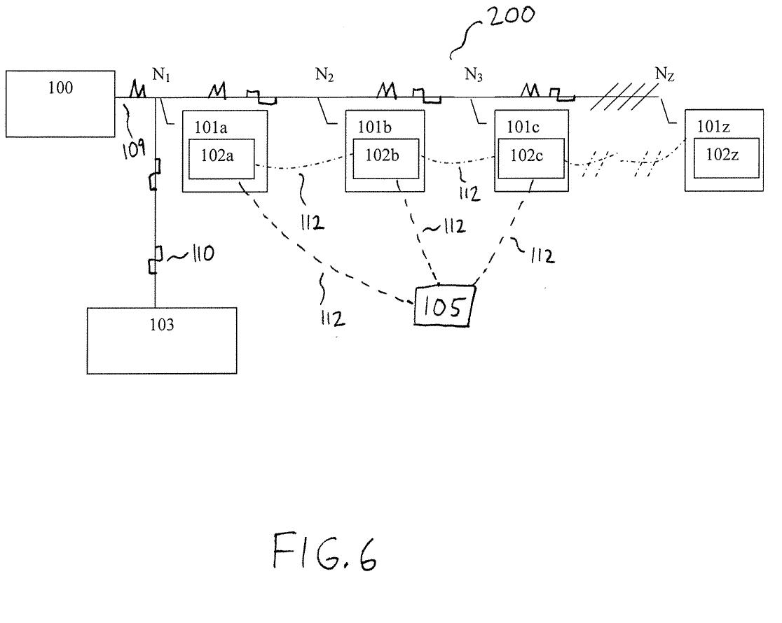

FIG. 6 is a schematic diagram of another embodiment, illustrating communication between a mobile personal device 105 and an out-of-band management network via a wireless connection. In FIG. 6, a mobile personal device 105 is shown connecting to the wireless components 102a through 102z of the management components 102a through 102z via a wirelessly transmitted signal 112. In this embodiment, the wireless BPL management network 200 allows management personnel who are onsite or within range of the wirelessly transmitted signal 112 to communicate wirelessly with each management component 101. This allows greater management capabilities without requiring physical access to the management component 101. With access through the wireless components, management functions can be performed even when both BPL connectivity and upstream out-of-band management are unavailable.

Embodiments provide the capability to reach from the management component located at one node of the BPL system to the next. While current industry practice requires the use of an additional wired network, the embodiments shown in FIGS. 2-8 provide for wireless connectivity between nodes. In addition, the use of wireless communications provides the capability to link each management component to other nodes beyond those immediately adjacent. In a hardwired out-of-band management system as commonly practiced in the industry, a single nonresponsive management component can disable communications with management equipment at nodes downstream. However, a wireless out-of-band management system, such as is shown in FIG. 2, can reach around the nonresponsive node and maintain management network connectivity. For example, if one management component is nonresponsive, the management component at the upstream node can communicate with the management component at the next available downstream node. This allows for the bypass of one or more nonfunctioning management components while maintaining out-of-band management capabilities.

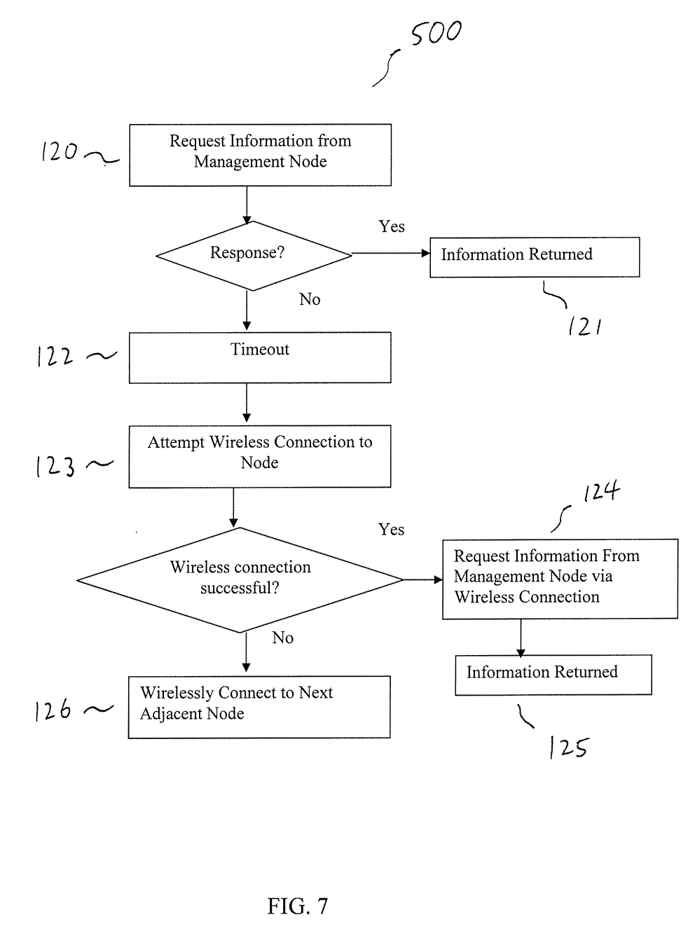

FIG. 7 is a flow chart illustrating a process 500 in which the wireless connection functions as a secondary management system while a primary management system communicates via a hard-wired connection. At step 120, network management tools access the management node to perform management or data collection operations. If a node is active, then it will respond with the requested information at step 121 via the hard-wired connection. If the connection “times-out” and no response is received at step 122, this indicates that either the node or the hard-wired connection to it has become nonresponsive. At step 123, the network management tools requesting data instruct the node adjacent to the nonresponsive management node to attempt a wireless connection. If the node is active but the hard-wired connection has been lost, then a second request for information can be sent via the wireless connection (step 124) and the management information can be communicated wirelessly as shown in step 125. If, however, the node itself has become nonresponsive, then the attempted wireless communication may also fail. In this case, at step 126, the node adjacent to the nonresponsive management node will be instructed to attempt a wireless connection with a node one position past the nonresponsive management mode.

Though process 500 has been described with reference to an embodiment in which the primary management system communicates via a hard-wired out-of-band connection, process 500 would also be applicable to an embodiment in which the primary management system communicates via the BPL connection.

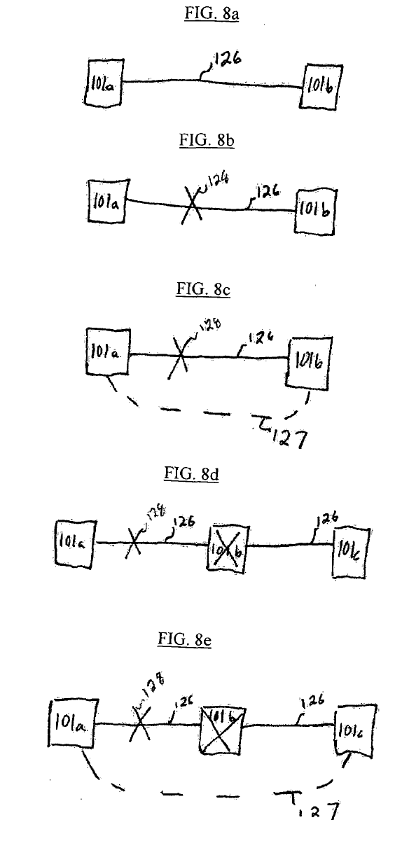

FIGS. 8a through 8e further illustrate the process presented in FIG. 5. In FIG. 8a, management components 101a and 101b are shown linked by a functioning hard-wired connection 126. FIG. 8b shows an interruption of communication 128 along the hard-wired connection 126. In FIG. 8c, management component 101a attempts a wireless connection to management component 101b. If the connection is successful, then management component 101b will communicate its data wirelessly to management component 101a. If the connection is unsuccessful, this indicates that the management component 101b is nonresponsive, as depicted in FIG. 8d. FIG. 8e shows the management component 101a connecting with the next adjacent management component 101c so that downstream management communication remains intact.

Though FIGS. 8a through 8e illustrate the process in the context of an embodiment in which the primary management system communicates via a hard-wired out-of-band connection 126, this process is equally applicable to an embodiment in which the primary management system communicates via the BPL connection.

The processes and devices in the above description illustrate an example of devices that could be used and produced to achieve the objects, features, and advantages of embodiments described herein. For example, multiple wireless protocols and standards exist which are adequate for use in embodiments described herein, including, but not limited to, other 802.11 (“WiFi”) and 802.16 (“WiMAX”) standards, as they are commonly known in the industry, as well as Bluetooth, SIG B, infrared, cellular, and S-Wave technologies, as they are commonly known in the industry. The adequacy of available wireless protocols and frequencies will depend upon the distance and terrain between nodes on the BPL system, the characteristics and configuration of the management signal, as well as other variables. Thus, the embodiments are not to be seen as limited by the foregoing description of the embodiments, but only limited by the appended claims.

What is claimed as new and desired to be protected by Letters Patent of the United States is:

1. A broadband over power lines management system, the system comprising:
a plurality of nodes at points on a power line;
a plurality of management components at said nodes;
at least one wireless component connected to least one of said management components, said wireless component configured to establish wireless communications between at least two of said plurality of management components.

2. The management system of claim 1 wherein said wireless communications include point-to-point wireless communications between a plurality of consecutive management components.

3. The management system of claim 1, wherein said wireless communications include point-to-multipoint wireless communications between a plurality of consecutive management components.

4. The management system of claim 1, wherein said wireless communications include point-to-point wireless communications between a plurality of nonconsecutive management components.

5. The management system of claim 1, wherein said wireless communications include point-to-multipoint wireless communications between a plurality of nonconsecutive management components.

6. The management system of claim 1, wherein said wireless communications include point-to-point wireless communications between a plurality of consecutive and nonconsecutive management components.

7. The management system of claim 1 wherein said wireless communications include point-to-multipoint wireless communications between a plurality of consecutive and nonconsecutive management components.

8. The management system of claim 1, wherein said wireless communications establish a primary network for communication with management components.

9. The management system of claim 1, wherein said wireless communications are bidirectional.

10. The management system of claim 1, wherein said wireless components are configured to communicate wirelessly with management personnel devices.

11. The management system of claim 1, wherein said system employs one or more wireless communications standards, including but not limited to the following standards and technologies as they are known in the industry: 802.11(a); 802.11(b); 802.11(g); 802.11(n); 802.16(a); 802.16(b); Bluetooth, SIG B, infrared, cellular, and S-Wave.

12. The management system of claim 1, wherein said management component is connected with a regenerator.

13. The management system of claim 1, wherein said management component is connected with a repeater.

14. The management system of claim 1, wherein said wireless communications establish a secondary network for communication with management components.

15. The management system of claim 14, further comprising a non-wireless primary network for communication with management components.

16. The management system of claim 15, wherein said primary network is an in-band management system.

17. The management system of claim 1, wherein said wireless communications are used to communicate with nonresponsive nodes when a primary connection to said nodes is unavailable.

18. The management system of claim 1, wherein said wireless communications are used to communicate with a node adjacent to a non-responsive node.

19. A method of managing broadband over power lines, the method comprising:
providing a plurality of management components for configuration, management, and monitoring of a BPL signal at nodes of a broadband over power lines system; and
linking at least two said management components via a wirelessly transmitted signal.

20. The method of claim 19, further comprising linking at least two consecutive management components via a wirelessly transmitted signal.

21. The method of claim 19, further comprising linking at least two nonconsecutive management components via a wirelessly transmitted signal.

22. The method of claim 19, further comprising linking at least two nonconsecutive management components and linking at least two consecutive management components.

23. The method of claim 19, further comprising linking said management components in a point-to-point configuration.

24. The method of claim 19, further comprising linking said management components in a point-to-multipoint configuration.

25. The method of claim 19, further comprising interfacing a wireless component with said management components, said wireless component configured to transmit and receive said wirelessly transmitted signal.

26. A method of communicating management information in a broadband over power lines system with a nonresponsive node or data connection, the method comprising the steps of:
sending a first request for management information to a first management node;
if said first management node does not return data within a specified amount of time, instructing a second management to connect to said first management node via a wireless connection; and
sending a second request for management information to said first management node via said wireless connection.

27. The method of claim 26, further comprising:
determining if the wireless connection was successful in communicating said management information; and
if said wireless connection is not determined to be successful, connecting to the next adjacent node.

28. The method of claim 26, wherein said first request is sent via a hard-wired out-of-band management network.

29. The method of claim 26, wherein said first request is sent via a BPL connection.

30. A device for providing out-of-band management for broadband over power lines, comprising:
a BPL interface component for interfacing with a BPL connection; and
a wireless component interfaced with said BPL interface component, said wireless component configured to transmit and receive a wirelessly transmitted signal.

31. The device of claim 30, further comprising a processor component for processing information about said BPL connection.

32. The device of claim 31, wherein said information includes system usage data and statistics.

33. The device of claim 30, further comprising a storage component for storing information about said BPL connection.

34. The device of claim 33, wherein said information includes system usage data and statistics.

35. The device of claim 30, wherein said device is configured to provide configuration, management, and monitoring capabilities.

36. The device of claim 30, wherein said device is configured to provide software installation and upgrades.

37. The device of claim 30, wherein said device is configured to provide hardware and power resets.

38. The device of claim 30, wherein said wireless component is configured to communicate with mobile personal devices.

39. The device of claim 30, wherein said wireless component is configured to communicate management information with wireless components at other nodes of a broadband over power lines system.

40. The device of claim 30, wherein said device is housed within a repeater.

41. The device of claim 30, wherein said device is housed within a regenerator.
